(19) United States
(12) Patent Application Publication
(10) Pub. No.: US 2023/0216150 A1
(43) Pub. Date: Jul. 6, 2023

(54) BUS BAR HOLDER, BUS BAR ASSEMBLY, AND BATTERY MODULE

(71) Applicant: Samsung SDI Co., Ltd., Yongin-si (KR)

(72) Inventor: Dooyong LIM, Yongin-si (KR)

(21) Appl. No.: 18/145,623

(22) Filed: Dec. 22, 2022

(30) Foreign Application Priority Data
Dec. 30, 2021 (KR) 10-2021-0193102

(51) Int. Cl. H01M 50/507; H02G 5/02; H01M 50/262

(52) U.S. Cl. CPC H01M 50/507; H02G 5/025; H01M 50/262

(57) ABSTRACT

A bus bar holder for a battery module is provided. The bus bar holder includes: a body having a plurality of bus bar disposal area portions; and a hinge portion between the plurality of bus bar disposal area portions and configured to enable stacking of the plurality of bus bar disposal area portions.

### CROSS-REFERENCE TO RELATED APPLICATION

This application claims priority to and the benefit of Korean Patent Application No. 10-2021-0193102, filed in the Korean Intellectual Property Office on Dec. 30, 2021, the entire content of which is incorporated herein by reference.

### BACKGROUND

### 1. Field

Aspects of embodiments of the present disclosure relate to a bus bar holder, a bus bar assembly including the bus bar holder, and a battery module including the bus bar assembly.

### 2. Description of the Related Art

A rechargeable battery differs from a primary battery in that a primary battery is designed to convert chemical energy into electrical energy in a non-reversible manner while a rechargeable battery is designed to be charged and discharged repeatedly. A low-capacity rechargeable battery can be used as a power source for small electronic devices, such as mobile phones, laptop computers, and camcorders, and a high-capacity rechargeable battery can be used as a power source for driving motors in hybrid and electric vehicles.

Generally, a rechargeable battery includes an electrode assembly that includes a positive electrode, a negative electrode, and a separator disposed between the positive electrode and the negative electrode, a case accommodating the electrode assembly, and an electrode terminal that is electrically connected to the electrode assembly. The case may have a cylindrical or rectangular shape depending on the battery's intended application, and an electrolyte solution is injected into the case such that the rechargeable battery can be charged and discharged through an electrochemical reaction between the positive electrode and the negative electrode.

A rechargeable battery may include a battery module formed of a plurality of unit batteries coupled to each other in series to, for example, drive a motor of a hybrid vehicle that requires high energy density. For example, the battery module may be formed by connecting electrode terminals of each of a plurality of unit batteries, in a manner and number according to the amount of power required to drive the motor, thereby realizing a rechargeable battery having high power.

The battery cells of the battery module are generally connected to each other by a bus bar. Because the primary function of the bus bar is to electrically connect the battery cells of the battery module to each other to transmit a current between the cells and between the battery modules, the bus bar is generally formed of a monolithic solid metal.

In recent years, as devices to which the battery module is applied (e.g., an electric vehicle) expands, the battery module (or battery cell) is also increasing in size, while the battery module itself needs to remain compact.

For example, the battery module should be configured such that not only the bus bar but also an electronic device (or electrical) parts connected to the bus bar can be supported by a holder and applied to the battery module.

The above information disclosed in this Background section is for enhancement of understanding of the background of the present disclosure, and therefore, it may contain information that does not form the prior art that is already known to a person of ordinary skill in the art.

### SUMMARY

One embodiment of the present disclosure provides a bus bar holder that is easy to combine with a bus bar and/or electronic device parts due to its improved structure.

Other embodiments of the present disclosure provide a bus bar assembly including the bus bar holder and a battery module including the bus bar assembly.

A bus bar holder for a battery module, according to one embodiment of the present disclosure, includes: a body having a plurality of bus bar disposal area portions; and a hinge portion between the plurality of bus bar disposal area portions and configured to enable stacking of the plurality of bus bar disposal area portions.

The body and the hinge portion may be integrally formed.

Each of the plurality of bus bar disposal area portions may have an opening for exposing a bus bar terminal portion.

In a state in which the plurality of bus bar disposal area portions are stacked, the opening in one of the plurality of bus bar disposal area portions may overlap the opening in another one of the plurality of bus bar disposal area portions.

The hinge portion may extend along a length of the body.

The bus bar holder for the battery module may further include a fastening portion adjacent to the hinge portion, and the fastening portion may be configured to fix the bus bar holder to a housing of the battery module.

The hinge portion and the fastening portion may extend along a length of the body.

The hinge portion may include a first hinge portion connected to one of the plurality of bus bar disposal area portions and a second hinge portion connected to another one of the plurality of bus bar disposal area portions. The fastening portion includes: a connection portion connected to the first hinge portion and the second hinge portion; and a support portion that forms an insertion space and connected to both ends of the connection portion.

The plurality of bus bar disposal area portions may include: a first bus bar disposal area portion; a second bus bar disposal area portion on one side of the first bus bar disposal area portion and stacked on the first bus bar disposal area portion by the hinge portion; and a third bus bar disposal area portion on another side of the first bus bar disposal area portion and stacked on the first bus bar disposal area portion by the hinge portion.

When the second bus bar disposal area portion and the third bus bar disposal area portion are stacked on the first bus bar disposal area portion, the second bus bar disposal area portion and the third bus bar disposal area portion may be spaced apart from each other.

The first bus bar disposal area portion, the second bus bar disposal area portion, and the third bus bar disposal area portion may each have a rectangular shape.

A bus bar assembly for a battery module, according to another embodiment of the present disclosure, includes: the bus bar holder as described above; and a bus bar in each of the plurality of bus bar disposal area portions.

The bus bars may be over-molded into the plurality of bus bar disposal area portions.

A battery module, according to another embodiment of the present disclosure, includes: a bus bar holder including a body, the body including a plurality of bus bar disposal area portions, a hinge portion between the plurality of bus bar disposal area portions and configured to enable the plurality of bus bar disposal area portions to be stacked, and a fastening portion adjacent to the hinge portion; a bus bar in each of the plurality of bus bar disposal area portions; and a housing accommodating a plurality of battery cells. The bus bar holder is fixed to the housing by the fastening portion of the body.

The housing may include a pair of side plates facing each other, and the fastening portion may be fixed to the pair of side plates.

The hinge portion may include a first hinge portion connected to one of the plurality of bus bar disposal area portions and a second hinge portion connected to another one of the plurality of bus bar disposal area portions, and the fastening portion may include: a connection portion connected to the first hinge portion and the second hinge portion; and a support portion connected to both ends of the connection portion and forming an insertion space, the side plates being inserted into the insertion space.

According to the embodiments of the present disclosure, the structure of the improved bus bar holder simplifies the manufacturing of the bus bar assembly by using fewer parts.

Accordingly, the manufacturing cost of the battery module may be reduced, and furthermore, a high-quality battery module can be provided to consumers.

### BRIEF DESCRIPTION OF THE DRAWINGS

Aspects and features of the present disclosure will be understood by a person of an ordinary skill in the technical field to which the present disclosure pertains through detailed descriptions of various embodiments with reference to the drawings, in which:

FIG. 1 is a perspective view of a bus bar assembly according to an embodiment of the present invention.

FIG. 2 is an exploded perspective view of the bus bar assembly shown in FIG. 1.

FIG. 3 is a side view of the bus bar assembly shown in FIG. 1.

FIG. 4A to 4E show steps of an assembling process of the bus bar assembly according to an embodiment of the present disclosure.

FIG. 5 shows a battery module to which the bus bar assembly according to an embodiment of the present disclosure is applied.

### DETAILED DESCRIPTION

Hereinafter, with reference to accompanying drawings, embodiments of the present disclosure will be described, in detail, such that a person of an ordinary skill in the technical field to which the present disclosure pertains may easily practice it. The drawings and description are to be regarded as illustrative in nature and not restrictive.

The accompanying drawings are for easy understanding of the embodiments described in this specification, and the technical idea disclosed in this specification is not limited by the accompanying drawing. It should be understood that all changes, equivalents, and/or substitutes included in the spirit and scope of the present disclosure are included.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of,” when preceding a list of elements, modify the entire list of elements and do not modify the individual elements of the list. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

In addition, in the entire specification, when an object is referred to as “on a plane”, it is viewed from above, and when an object is referred to as “on a cross-section”, it is viewed from the side when the object is cut vertically.

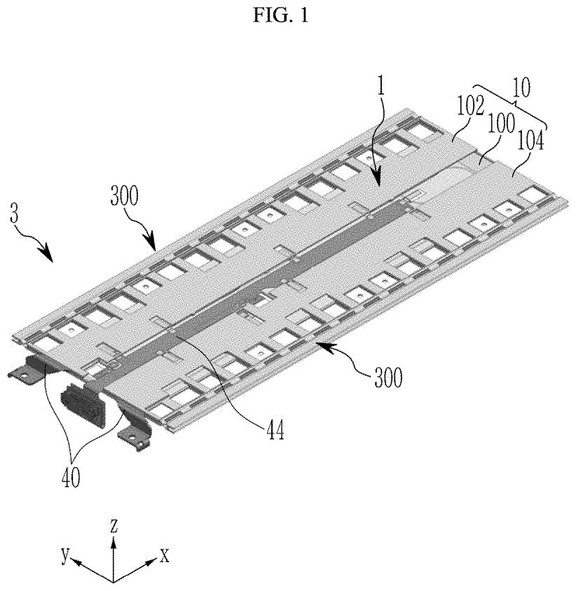

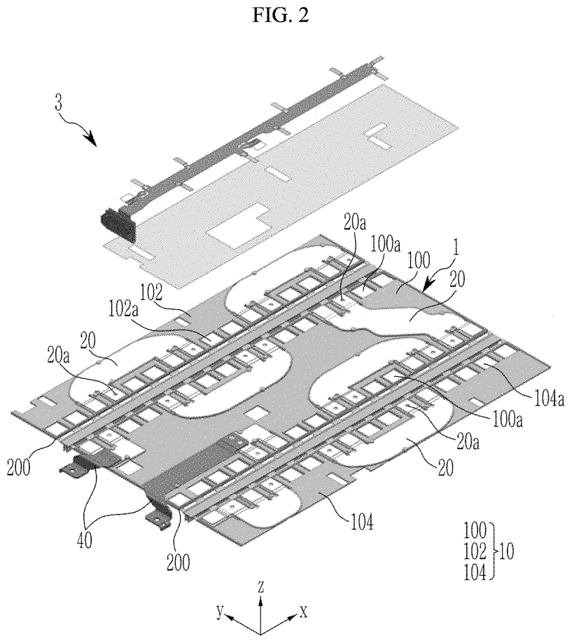

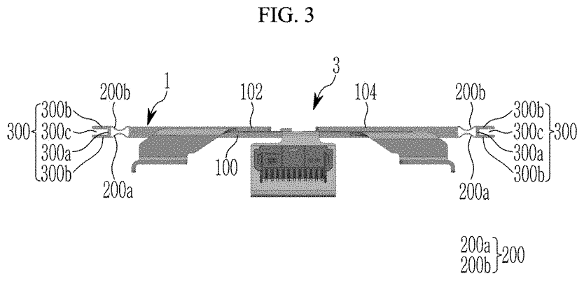

FIG. 1 is a perspective view of a bus bar assembly according to an embodiment of the present disclosure, FIG. 2 is an exploded perspective view of the bus bar assembly shown in FIG. 1, and FIG. 3 is a side view of the bus bar assembly shown in FIG. 1.

A bus bar assembly, according to an embodiment, is formed by fixing a bus bar to a bus bar holder. In some embodiments, the bus bar assembly is configured such that bus bars are arranged in a plurality of layers, for example, in two layers. Such a bus bar assembly is provided to a battery module and electrically connects a plurality of rechargeable battery cells accommodated in a housing of the battery module to each other.

As shown in FIGS. 1 to 3, a bus bar holder 1 includes a resin material body 10 including a plurality of bus bar disposal area portions 100, 102, and 104 in which the bus bar(s) 20 is/are disposed. A bus bar 20 is disposed in each of the bus bar disposal area portions 100, 102, and 104, and the number of bus bars 20 disposed in each bus bar disposal area portions 100, 102, and 104 may be determined according to the number of battery cells and an electrical connection relationship of the battery cells.

In addition, openings 100a, 102a, and 104a for exposing a terminal part of the bus bar 20 are arranged along one direction (e.g., a length direction of the body, the x direction in the figures) in each of the bus bar disposal area portions 100, 102, and 104.

In the illustrated embodiment, the bus bar holder 1 has three bus bar disposal area portions 100, 102, and 104. Each of the bus bar disposal area portions 100, 102, and 104 has an approximately rectangular periphery (or outline).

From among the three bus bar disposal area portions 100, 102, and 104, the first bus bar disposal area portion 100 is disposed in a center of the bus bar holder 1 and has a larger size than the second and third bus bar disposal area portions 102 and 104. The second and third bus bar disposal area portions 102 and 104 are disposed on the left and right sides of the first bus bar disposal area portion 100 while neighboring the first bus bar disposal area portion 100. The second and third bus bar disposal area portions 102 and 104 have a smaller size than the first bus bar disposal area portion 100 and are connected with (e.g., extend from) the first bus bar disposal area portion 100 to be stacked on the first bus bar disposal area portion 100. The size of the second bus bar disposal area portion 102 and the size of the third bus bar disposal area portion 104 may be the same.

Hinge portions 200 are disposed between the first bus bar disposal area portion 100 and the second bus bar disposal area portion 102 and between the first bus bar disposal area portion 100 and the third bus bar disposal area portion 104 to facilitate stacking of the bus bar disposal area portions 100, 102, and 104.

In the one embodiment, the hinge portion 200 may have a thinner thickness than the bus bar disposal area portions 100, 102, and 104 to be flexible (or more flexible). The hinge portion 200 is formed of the same resin material as the body 10 and may be integrally formed with the bus bar disposal area portions 100, 102, and 104 through injection molding or the like. In addition, the hinge portion 200 may extend discontinuously along the length direction of the body 10 (e.g., the x direction) such that the hinge portion 200 may only be disposed between the openings 100a, 102a, and 104a of the bus bar disposal area portions 100, 102, and 104 to connect the first bus bar disposal area portion 100 and the second bus bar disposal area portion 102 and to connect the first bus bar disposal area portion 100 and the third bus bar disposal area portion 104.

The second bus bar disposal area portion 102 and the third bus bar disposal area portion 104 are shown in an unfolded state (e.g., a state in which the hinge portions 200 are unfolded or are flat) in FIG. 2, and the hinge portions 200 may rotate about 180 degrees toward the first bus bar disposal area portion 100 such that the second bus bar disposal area portion 102 and the third bus bar disposal area portion 104 are stacked on (e.g., folded to overlap) the first bus bar disposal area portion 100. In a folded (or stacked) state, the opening 102a (e.g., one of the openings 102a) in the second bus bar disposal area portion 102 may overlap the opening 100a (e.g., one of the openings 100a) in the first bus bar disposal area portion 100, and the opening 104a (e.g., one of the openings 104a) in the third bus bar disposal area portion 104 may overlap the opening 100a (e.g., another one of the openings 100a) in the first bus bar disposal area portion 100.

The bus bar holder 1 may include a fastening portion 300 configured to fix the bus bar assembly 3 to a housing of a battery module adjacent to the hinge portion 200.

In the illustrated embodiment, the hinge portion 200 includes (e.g., is divided into) a first hinge portion 200a connected to the first bus bar disposal area portion 100 and a second hinge portion 200b connected to the second and third bus bar disposal area portions 102 and 104. The fastening portion 300 may include a connection portion 300a disposed between the first hinge portion 200a and the second hinge portion 200b and connected thereto, and a support portion 300b extending vertically from both ends (e.g., opposite ends) of the connection portion 300a with respect to the connection portion 300a to form an insertion space 300c between the support portions 300b.

The connection portion 300a and both support portions 300b that form the fastening portion 300 may have a thickness such that they can receive (or absorb) force when the components of the housing of the battery module are inserted into the insertion space 300c.

As shown in FIGS. 1 and 3, which show the bus bar holder 1 in the folded state in which the second and third bus bar disposal area portions 102 and 104 are stacked on the first bus bar disposal area portion 100, the fastening portion 300 is disposed continuously along the length direction of the body 10 (e.g., the x direction) and another fastening portion 300 is arranged opposite to the fastening portion 300 at both edges of the first bus bar disposal area portion 100. In such an embodiment, both support portions 300b of the fastening portion 300 are disposed side by side in a form extending outwardly from the bus bar holder 1 such that the insertion space 300c may be maintained in an open state.

The bus bar holder 1, an embodiment of which is described above, may be configured as the bus bar assembly 3 by disposing a bus bar 20 to each of the plurality of bus bar disposal area portions 100, 102, and 104. In the illustrated embodiment, the bus bar holder 1 and the bus bar 20 may be formed together through over-molding to form the bus bar assembly 3.

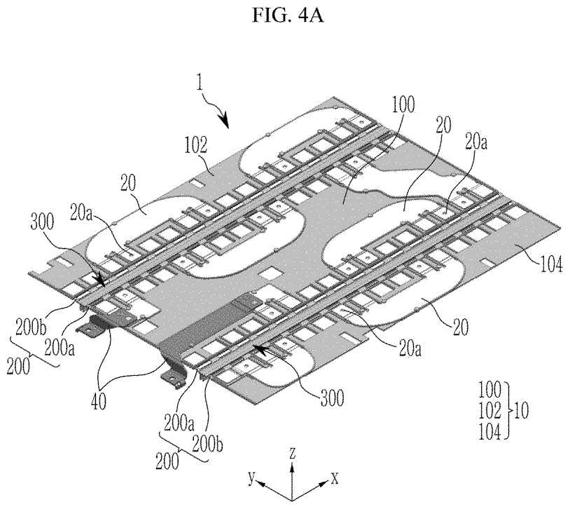

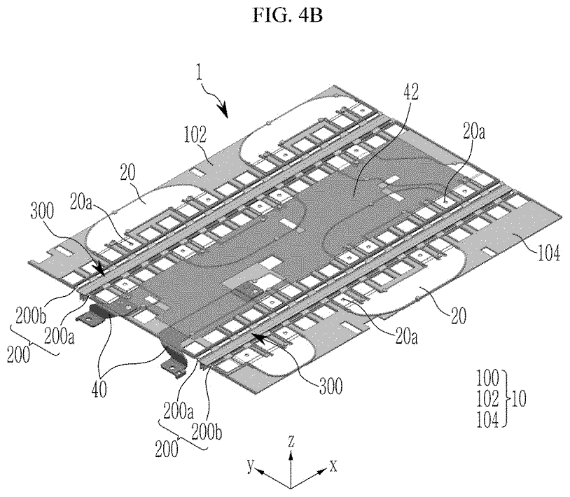

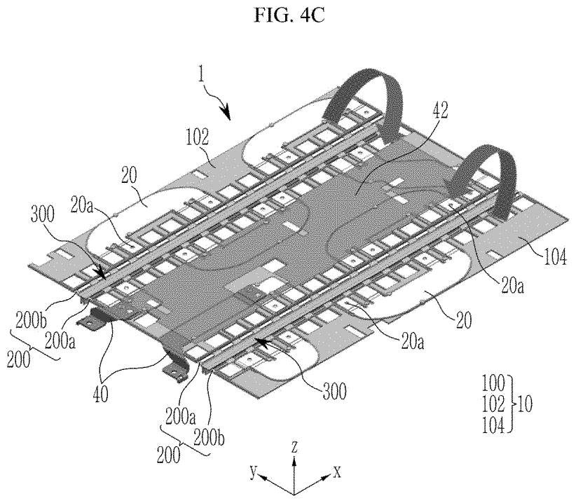

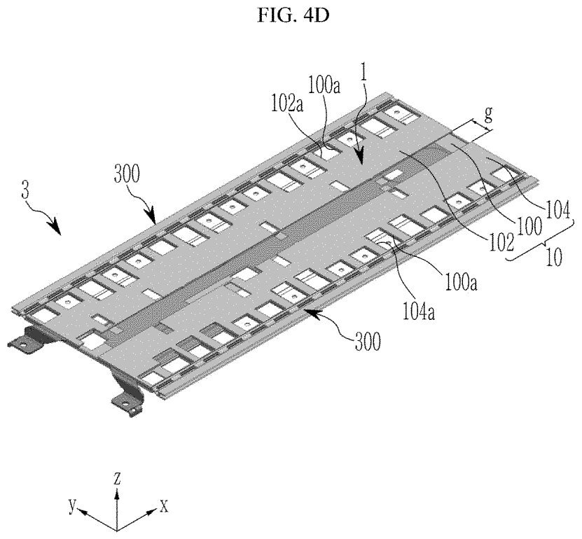

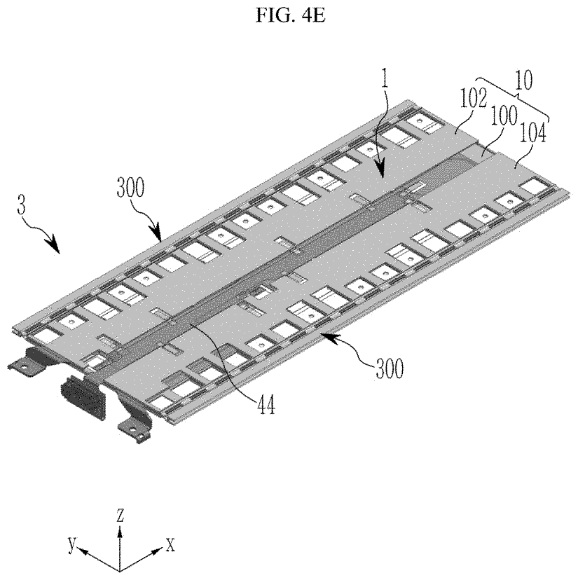

FIG. 4A to FIG. 4E show steps of an assembling process of the bus bar assembly according to an embodiment of the present disclosure.

The above-described bus bar holder 1 may be formed through injection molding. Referring to FIG. 4A, during the injection molding, the bus bar disposal area portions 100, 102, and 104 are over-molded with the corresponding bus bar(s) 20. For example, five bus bars 20 are disposed on and over-molded into the first bus bar disposal area portion 100 and two bus bars 20 are respectively disposed on and over-molded into the second bus bar disposal area portion 102 and the third bus bar disposal area portion 104. In such an embodiment, the second bus bar disposal area portion 102 and the third bus bar disposal area portion 104 are maintained in an unfolded state, and a flexible print circuit 40 may be connected to some of the bus bars 20 disposed to the first bus bar disposal area portion 100.

When disposing the bus bar 20 to each of the bus bar disposal area portions 100, 102, and 104, the bus bar 20 may not be disposed at the exact position of each bus bar disposal area portion 100, 102, and 104 (e.g., the shape of the bus bars 20 is similar such that the bus bar 20 may not be disposed at the exact position of each bus bar disposal area portion 100, 102, and 104). Thus, in some embodiments, a hole (e.g., an opening) 20a may be formed in a terminal portion of the bus bar 20, but the position and number of the holes 20a are different for each bus bar 20 to classify the bus bar 20, thereby ensuring that each bus bar 20 may be assembled to the correct (e.g., exact) position of the corresponding bus bar disposal area portions 100, 102, and 104. In other words, the hole 20a may be provided in the bus bar 20 to assist workers in assembling the bus bar holder 1.

Next, referring to FIG. 4B, an insulating sheet 42 may be disposed on the first bus bar disposal area portion 100. The insulating sheet 42 insulates between the bus bar(s) 20 disposed in the plurality of bus bar disposal area portions 100, 102, and 104.

Next, referring to FIG. 4C, the second bus bar disposal area portion 102 and the third bus bar disposal area portion 104 are folded and stacked on (e.g., are folded toward to overlap) the first bus bar disposal area portion 100 at the hinge portions 200.

As shown in FIG. 4D, when the second bus bar disposal area portion 102 and the third bus bar disposal area portion 104 are each folded at the respective hinge portions 200 such that the plurality of bus bar disposal area portions 100, 102, and 104 are stacked as a two-layer structure, the opening(s) 102a in the second bus bar disposal area portion 102 overlaps the opening(s) 100a in the first bus bar disposal area portion 100, and the opening(s) 104a in the third bus bar disposal area portion 104 overlaps the opening(s) 100a in the first bus bar disposal area portion 100. In the folded state, the second bus bar disposal area portion 102 and the third bus bar disposal area portion 104 are spaced apart by an interval g.

Next, referring to FIG. 4E, another flexible print circuit 44 for sensing is disposed in the interval g between the second bus bar disposal area portion 102 and the third bus bar disposal area portion 104, and each bus bar 20 is electrically connected to the flexible print circuit 44 to complete the assembly of the bus bar assembly 3.

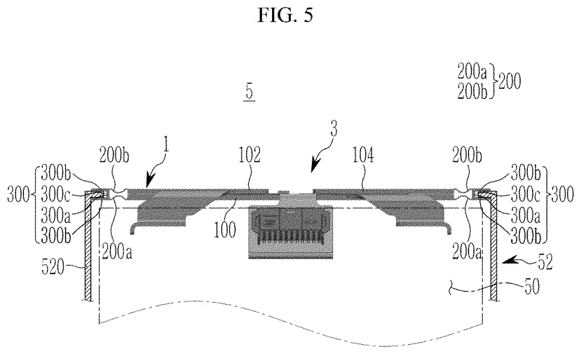

The assembled bus bar assembly 3 may be connected to a housing of a battery module. FIG. 5 shows a battery module 5 according to an embodiment of the present disclosure, and, as shown in FIG. 5, the bus bar assembly 3 may be disposed on (or at) the top of the housing 52 in which a plurality of battery cell (e.g., lithium rechargeable battery cell) arrays 50 are accommodated and connected to a side plate 520 of the housing 52.

The housing 52 may include a combination of a pair of end plates and a pair of side plates 520. In the illustrated embodiment, the battery module 5 is formed by connecting the bus bar assembly 3 to the pair of side plates 520.

When viewing a coupling structure (or configuration) between the side plate 520 and the bus bar assembly 3, the bus bar assembly 3 is provided above the battery cell array 50 accommodated in the housing 52 and both fastening portions 300 of the bus bar holder 1 are positioned at the end of both side plates 520 of the housing 52. In the illustrated embodiment, the ends of both side plates 520 are inserted into respective ones of the insertion spaces 300c in the fastening portions 300.

The insertion may be carried out as a force fit insertion. Due to a fixing force generated between the fastening portions 300 and the side plates 520, the bus bar assembly 3 is fixed to the housing 52 and the bus bar assembly 3 fixes the battery cell array 50. The coupling between the fastening portions 300 and the housing 52 is not limited to the force fit method. For example, in a state in which the end of the side plate 520 is inserted into the insertion spaces 300c in the fastening portions 300, the support portions 300b of the fastening portions 300 and the end of the side plates 520 may be fixed through welding.

While this disclosure has been described in connection with what is presently considered to be practical embodiments, it is to be understood that the present disclosure is not limited to the described embodiments. The present disclosure is intended to cover various modifications and equivalent arrangements included within the spirit and scope of the appended claims and their equivalents.

### DESCRIPTION OF SOME SYMBOLS

1: bus bar holder
3: bus bar assembly
5: battery module
20: bus bar
20a: hole
40: flexible print circuit
44: flexible print circuit
100, 102, 104: bus bar disposal area portion
100a, 102a, 104a: openings
200: hinge portion
300: fastening portion

What is claimed is:

1. A bus bar holder for a battery module, the bus bar holder comprising:
a body having a plurality of bus bar disposal area portions; and
a hinge portion between the plurality of bus bar disposal area portions and configured to enable stacking of the plurality of bus bar disposal area portions.

2. The bus bar holder for the battery module of claim 1, wherein the body and the hinge portion are integrally formed.

3. The bus bar holder for the battery module of claim 1, wherein each of the plurality of bus bar disposal area portions has an opening for exposing a bus bar terminal portion.

4. The bus bar holder for the battery module of claim 3, wherein, in a state in which the plurality of bus bar disposal area portions are stacked, the opening in one of the plurality of bus bar disposal area portions overlaps the opening in another one of the plurality of bus bar disposal area portions.

5. The bus bar holder for the battery module of claim 1, wherein the hinge portion extends along a length of the body.

6. The bus bar holder for the battery module of claim 1, further comprising a fastening portion adjacent to the hinge portion, the fastening portion configured to fix the bus bar holder to a housing of the battery module.

7. The bus bar holder for the battery module of claim 6, wherein the hinge portion and the fastening portion extend along a length of the body.

8. The bus bar holder for the battery module of claim 7, wherein the hinge portion comprises a first hinge portion connected to one of the plurality of bus bar disposal area portions and a second hinge portion connected to another one of the plurality of bus bar disposal area portions, and
wherein the fastening portion comprises:
a connection portion connected to the first hinge portion and the second hinge portion; and
a support portion that forms an insertion space and connected to both ends of the connection portion.

9. The bus bar holder for the battery module of claim 8, wherein the plurality of bus bar disposal area portions comprises:
a first bus bar disposal area portion;
a second bus bar disposal area portion on one side of the first bus bar disposal area portion and stacked on the first bus bar disposal area portion by the hinge portion; and
a third bus bar disposal area portion on another side of the first bus bar disposal area portion and stacked on the first bus bar disposal area portion by the hinge portion.

10. The bus bar holder for the battery module of claim 9, wherein, when the second bus bar disposal area portion and the third bus bar disposal area portion are stacked on the first bus bar disposal area portion, the second bus bar disposal area portion and the third bus bar disposal area portion are spaced apart from each other.

11. The bus bar holder for the battery module of claim 10, wherein the first bus bar disposal area portion, the second bus bar disposal area portion, and the third bus bar disposal area portion each have a rectangular shape.

12. A bus bar assembly for a battery module, the bus bar assembly comprising:
the bus bar holder of claim 1; and
a bus bar in each of the plurality of bus bar disposal area portions.

13. The bus bar assembly for the battery module of claim 12, wherein the bus bars are over-molded into the plurality of bus bar disposal area portions.

14. A battery module comprising:
a bus bar holder comprising a body, the body comprising a plurality of bus bar disposal area portions, a hinge portion between the plurality of bus bar disposal area portions and configured to enable the plurality of bus bar disposal area portions to be stacked, and a fastening portion adjacent to the hinge portion;
a bus bar in each of the plurality of bus bar disposal area portions; and
a housing accommodating a plurality of battery cells, the bus bar holder being fixed to the housing by the fastening portion of the body.

15. The battery module of claim 14, wherein the housing comprises a pair of side plates facing each other, and
wherein the fastening portion is fixed to the pair of side plates.

16. The battery module of claim 15, wherein the hinge portion comprises a first hinge portion connected to one of the plurality of bus bar disposal area portions and a second hinge portion connected to another one of the plurality of bus bar disposal area portions, and
wherein the fastening portion comprises:
a connection portion connected to the first hinge portion and the second hinge portion; and
a support portion connected to both ends of the connection portion and forming an insertion space, the side plates being inserted into the insertion space.
